(19) United States
(12) Patent Application Publication
(10) Pub. No.: US 2014/0016337 A1
(43) Pub. Date: Jan. 16, 2014

(54) E-Z Guider Semi Trailer Lighting System

(71) Applicant: Clint R. Younger, Newark, NJ (US)

(72) Inventor: Clint R. Younger, Newark, NJ (US)

(21) Appl. No.: 13/548,172

(22) Filed: Jul. 12, 2012

(51) Int. Cl. B60Q 1/22

(52) U.S. Cl. 362/485

(57) ABSTRACT

The E-Z Guider would consist of eight lights (four on each side of the trailer), each measuring 4 inches in height by 6 inches in length, and situated near or on the chrome at the top and bottom of each side of the trailer, on both the front and back ends.

### BRIEF DESCRIPTION OF THE DRAWINGS

FIG. 1 is an illustrative view of a truck and semi trailer backing up in the dark at a loading and unloading dock.

FIG. 2 is a functional perspective view of the present invention showing how a light housing opens in a horizontal arc for widest peripheral illumination and how the light pivots up and down and left to right for more specific focus of a direct beam.

FIG. 3 is a top functional perspective view showing a truck rig on a highway in darkness. A cab's bright headlights beam out from the front and a semi trailer's side lights of the present invention illuminate peripherally in wide arcs.

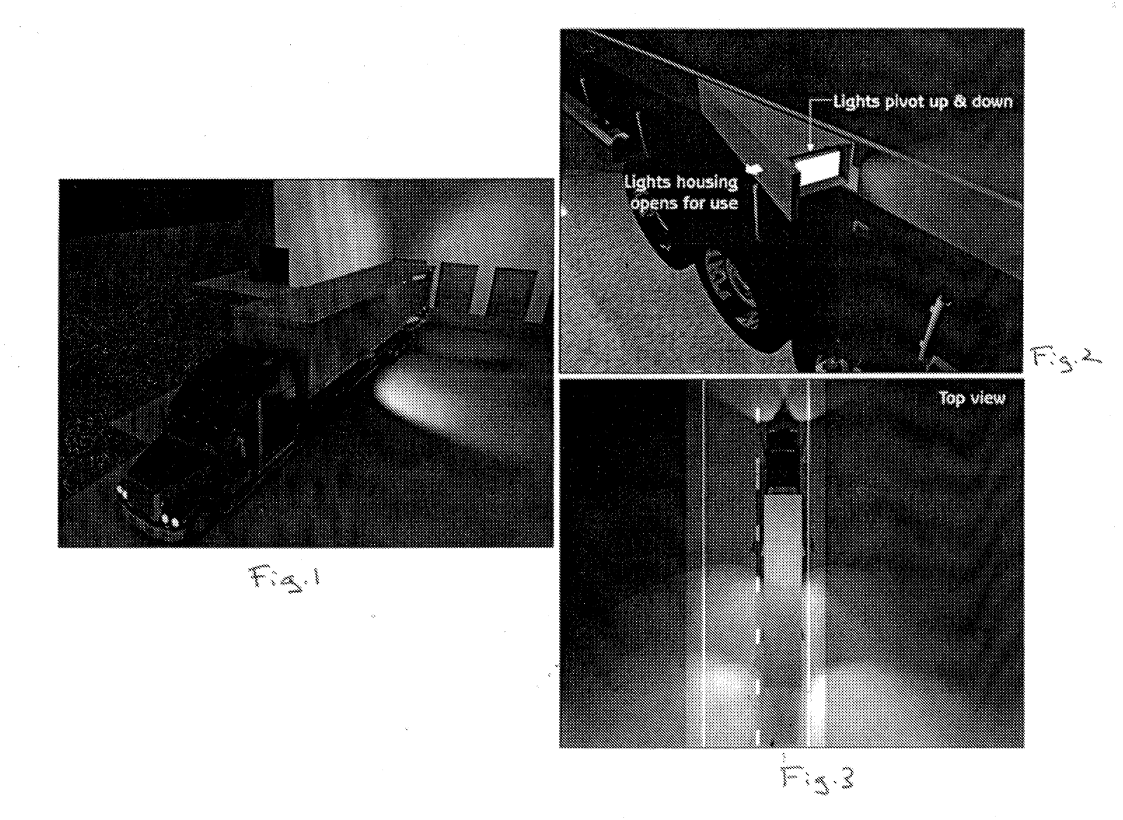

### DETAILED DESCRIPTION OF THE INVENTION

Almost all of us today rely upon a vast network of strangers to bring us the essentials of life, the goods and products we use every day as consumers. The complicated networks of production, transport and distribution stretch invisibly between consumers and producers. Among the challenges of long haul trucking are the physical strain of driving for long hours at a stretch, the frustrations of traffic and gridlock, living on the road and working behind the wheel. When the trucker finally arrives at his or her destination, a major challenge is backing the trailer up to a bay or loading dock. Truckers frequently back their trailer down a dark tunnel or alley and often are backing up blindly in the dark. Such conditions often result in colliding into an unseen object and damaging the trailer and possibly its contents. These mishaps result in higher insurance premiums for truckers and trucking companies.

The present invention, hereinafter referred to as the E-Z Guider, addresses the need for truckers to have ample side lighting when backing a trailer down a dark alley, tunnel or other narrow passage. The E-Z Guider is a system of sidelights placed top and bottom midway along the trailer. Each light of the E-Z Guider is swivel mounted within its base and is concealed within an opaque cover when not in use, and are operated by a switch located within the tractor's cab. This separate switch is located next to the On/Off switch to control the swivel action of the lights. It is envisioned that this switch operates much like the switches used to control side mirrors on many vehicles, thereby moving the lights up, down, left and right.

The E-Z Guider system consists of four lights, each measuring approximately four inches in height by six inches in length, and situated near the top and bottom of each side of the trailer at its midpoint. The lights are covered by inconspicuous opaque covers when not in use and are utilized in the dark to navigate narrow backing situations. The covers are a sliding sheath design that requires small electric motors and a geared track drive system. The truck driver opens and closes the sidelights by an activation switch in cab. This Off and On switch is located on the cab's dashboard or inner panel door. Flipping this switch to an On position opens the covers and turns on the E-Z Guider lights. Flipping this switch to an Off position extinguishes the lights and closes the covers.

The E-Z Guider system of trailer side lighting enables truckers backing their trailers down dark alleys, tunnels and similar tight passages to illuminate these passages sufficiently to be seen easily in their rearview mirrors. The E-Z Guider avoids errant steering of the trailer and inadvertent sideswiping collisions with walls or other adjacent structures or objects. When not in use, the E-Z Guider lights remain discreetly covered and protected. The E-Z Guider light covers open only when the lights are activated. Having a trailer equipped with the E-Z Guider facilitates a trucker's backing process tremendously.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. It is an object of the present invention to provide a side lighting system for backing semi trailers in darkness.
